(19) United States
(12) Patent Application Publication
(10) Pub. No.: US 2006/0116109 A1
(43) Pub. Date: Jun. 1, 2006

(54) Pre-authenticated message delivery for wireless local area networks

(76) Inventors: Victor B. Lortz, Beaverton, OR (US); Farid Adrangi, Lake Oswego, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/001,553

(22) Filed: Nov. 30, 2004

(51) Int. Cl. H04Q 7/20

(52) U.S. Cl. 455/412.2; 455/412.1

(57) ABSTRACT

Sending message notifications to a mobile station without requiring the mobile station to fully connect to a fee-based access point for a wireless network. A message notification system registers the mobile station as ready to receive a message notification, receives a message addressed to the mobile station from a sender, generates a message notification based on the message, and transmits the message notification to the mobile station through the access point. The fee-based access point allows the mobile station to partially connect to the access point without incurring a fee. The access point receives a registration request from the mobile station, forwards the registration request to the message notification system, receives the message notification from the message notification system, waits for a poll message from the mobile station, and forwards the message notification to the mobile station when the poll message is received.

### BACKGROUND

In a conventional wireless infrastructure network, mobile stations (e.g., a laptop computer with a wireless connection) are associated with a wireless access point (AP) within a basic service set. The wireless network may be open to the general public, and users are generally charged a service fee for connecting their mobile station to such a public wireless network. Users must first authenticate themselves to the public wireless network to obtain access. After the authentication process is performed, the public wireless network generates accounting records for the user detailing resource consumption such as connection time and/or bandwidth usage.

Currently, users cannot use a public wireless network to receive message notifications or messages unless they are authenticated and connected. In service fee-based public wireless networks, a user will have to incur usage-based fees to check for such message notifications or messages. In deciding whether to pay a service fee to connect to the public wireless network, a user typically must weigh the trade-offs between the cost of such a connection and the expected value of the connectivity. The costs incurred include both monetary costs (i.e., the service fee) and resource costs (i.e., the increased use of battery life to power a wireless card). If the costs incurred are high and the user's perceived need for data services is low, the user is unlikely to attempt a connection. This results in a loss of potential revenue for the public wireless network provider and this may also prevent the user from receiving important messages.

### BRIEF DESCRIPTION OF THE DRAWINGS

FIG. 1 is a network that includes a message notification system according to one implementation of the invention.

FIG. 2 is a method for a mobile station to become authorized with a message notification system according to an implementation of the invention.

FIG. 3 is a method for a message notification to be transmitted from a sender to the mobile station according to an implementation of the invention.

FIG. 4 is a method for a message notification to be transmitted from a sender to the mobile station according to another implementation of the invention.

FIG. 5 is a method for a message notification to be delivered to the mobile station according to another implementation of the invention.

### DETAILED DESCRIPTION

The following description, various aspects of the illustrative implementations will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative implementations. However, it will be apparent to one skilled in the art that the present invention may be practiced without the specific details. In other instances, well-known circuits, structures and techniques have not been shown in detail in order not to obscure an understanding of this description.

References to “one implementation”, “an implementation”, “example implementation”, “various implementations”, etc., indicate that the implementation(s) of the invention so described may include a particular feature, structure, or characteristic, but not every implementation necessarily includes the particular feature, structure, or characteristic. Further, the different implementations described may have some, all, or none of the features described for other implementations.

The term “processor” may refer to any device or portion of a device that processes electronic data from registers and/or memory to transform that electronic data into other electronic data that may be stored in registers and/or memory. A “computing platform” may comprise one or more processors.

The term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some implementations they might not.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner. Various operations will be described as multiple discrete operations, in turn, in a manner that is most helpful in understanding the present invention, however, the order of description should not be construed to imply that these operations are necessarily order dependent. In particular, these operations need not be performed in the order of presentation.

Implementations of the invention enable a mobile station to register its presence on a network without authenticating or maintaining an active connection. This allows a message sender to contact the mobile station (i.e., a user of the mobile station) while the mobile station is not fully connected to the network. A sender may contact the mobile station even while the mobile station periodically sleeps to further reduce power consumption. In some implementations, when a sender transmits a message to the mobile station, the mobile station may receive a message notification that identifies the sender but does not include the full message. The mobile station may then establish a full connection to the network to receive the full message. In some implementations, when a sender transmits a message to the mobile station, the mobile station may receive the full message instead of a message notification. The mobile station may then establish a full connection to the network to respond to the message.

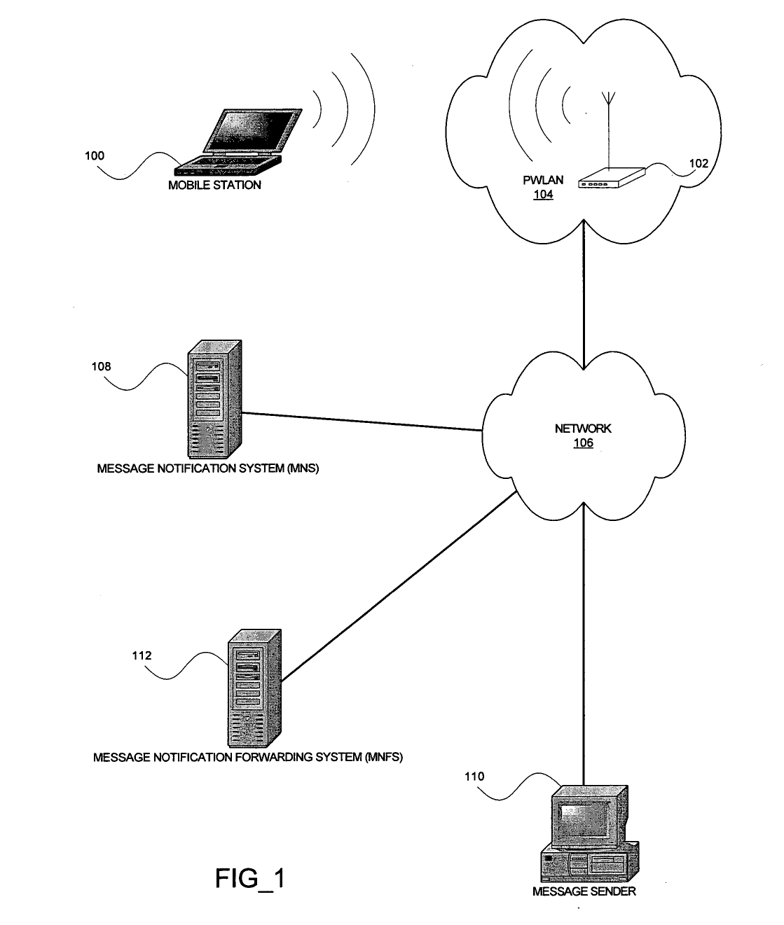

FIG. 1 illustrates one implementation of a network that includes a message notification system in accordance with the invention. A mobile station 100 is a client device that may include, but is not limited to, a laptop computer, a notebook computer, a personal digital assistant (PDA), a pager, and a mobile telephone. The mobile station 100 includes wireless communication functionality and may communicate with a wireless access point (AP) 102. This wireless communication functionality may be enabled by a wireless card (not shown) in the mobile station 100. The AP 102 may establish a wireless local area network (WLAN) that the mobile station 100 may join by fully connecting to the AP 102. The WLAN established by the AP 102 may be a public wireless local area network (PWLAN) 104. In some implementations, the WLAN may be implemented using IEEE 802.11 protocols or IEEE 802.16 protocols.

The AP 102 may be a basic service set that is coupled to a network 106 such as the Internet. Through the network 106, the AP 102 may be coupled to a message notification system (MNS) 108. The AP 102 may also be connected to a service provider through the network 106, for example, a company that provides and maintains the PWLAN 104.

The MNS 108 may be a computing system, such as a computer, that includes at least a processor and a memory. The MNS 108 may include server software that carries out at least some of the methods of the invention. The MNS 108 may be coupled to a sender 110 through the network 106. The sender 110 may be any entity that can send a message to the mobile station 100. For instance, the sender 110 may be a person that is a friend, an associate, a co-worker, or family of the user of the mobile station 100. The sender 110 may even be a business or other organization that can send a message to the user of the mobile station 100.

In some implementations, the network that couples the AP 102 to the MNS 108 may be different than the network that couples the MNS 108 to the sender 110. In some implementations, the networks may be the same. In some implementations, the AP 102 may be coupled to the MNS 108 through the Internet and the MNS 108 may be coupled to the sender 110 through the Internet.

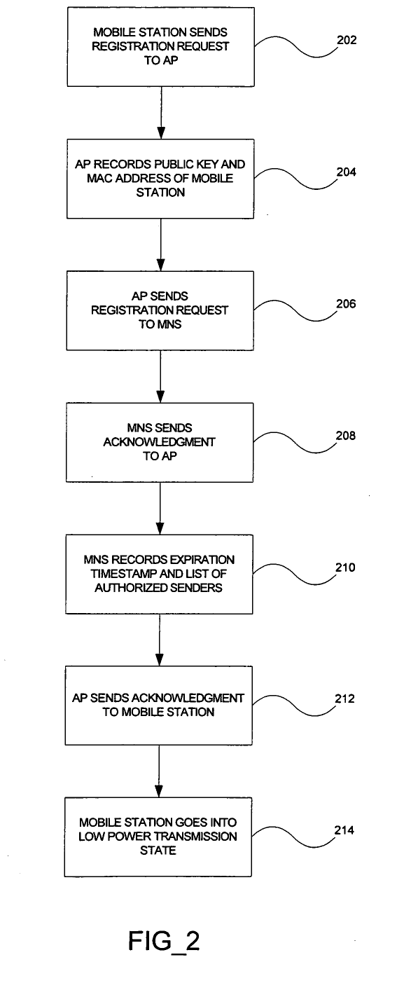

FIG. 2 is a method for the mobile station 102 to register its presence on a network to receive message notifications from a sender 110. In an implementation, the mobile station 100 may register its presence by informing the MNS 108 that the mobile station 100 is ready to receive message notifications. The mobile station 100 may do this by wirelessly transmitting a registration request to the AP 102 (process 202 of FIG. 2). In accordance with the invention, the registration request is a message that includes data intended for both the AP 102 and for the MNS 108.

For the AP 102, the registration request may provide a domain name, an Internet Protocol (IP) address, or other information suitable for routing the registration request to the MNS 108. The registration request may also provide an anonymous public key that identifies the mobile station 100. The use of an anonymous public key helps maintain user privacy because it does not contain identifying information that may compromise personal data. In some implementations, the registration request may provide an identifier other than a public key for the mobile station 100.

For the MNS 108, the registration request may include an expiration timestamp that defines a time period during which the mobile station 100 is available for message notifications from the MNS 108. The registration request may also include a list of one or more senders 110 that are authorized to contact the mobile station 100 through the MNS 108. The list may include the public keys or other identifiers for such senders 110.

Although not required, in some implementations the registration request may be a pre-authenticated registration message that is digitally-signed. In some implementations, the registration request may be provided through an information element extension in an IEEE 802.11 probe request. In some implementations, the registration request may use IEEE 802.16 MAC layer protocols. It should be noted that a trust relationship may not be required between the mobile station 100 and the AP 102 because the registration request may be self-protecting.

The AP 102 receives the registration request and records the public key or other identifier for the mobile station if provided (process 204). The AP 102 may also record a Media Access Control (MAC) address for the mobile station 100 (process 204). The MAC address may be transmitted to the AP 102 in the registration request or it may be received separate from the registration request, for instance, when the mobile station 100 activates its wireless functionality and initially contacts the AP 102. The AP 102 may use both the recorded public key and the recorded MAC address to route message notifications to the mobile station 100. The AP 102 then uses the information from the registration request to forward the registration request to the MNS 108 (process 206). The registration request is generally transmitted between the AP 102 and the MNS 108 over a network such as the Internet.

When the MNS 108 receives the registration request, it may transmit an acknowledgement back to the AP 102 over the same network (process 208). The MNS 108 may parse the registration request to record the expiration timestamp for the registration (process 210). In some implementations, the MNS 108 may only transmit message notifications to the mobile station 100 during the time period when the registration is active. Once the registration expires, the MNS 108 may no longer transmit message notifications to the mobile station 100. The MNS 108 may also parse the registration request to record the list of public keys of authorized senders 110 if provided. The MNS 108 may record this list (process 210) and use it to authenticate senders 110 that attempt to contact the mobile station 100, as described below.

In some implementations, the MNS 108 may match the public key provided in the registration request to a previously defined user account. For example, the MNS 108 may maintain a mapping between the public key and data stored in the user account. The user account may include alternate identifiers for the mobile station 100, such as a user name associated with the mobile station 100. This enables a sender 110 to address their message to the user name or other identifier rather than a public key which the sender 110 may not know. In some implementations, the MNS 108 will not have a previously defined user account and will simply record the public key provided in the registration request.

In some implementations of the invention, the MNS 108 may receive a domain name or an IP address for the AP 102. In other implementations, the MNS 108 may receive a domain name or an IP address for a message notification forwarding service (MNFS) 112 associated with the AP 102 and/or associated with the service provider for the AP 102. For example, if the AP 102 provides a PWLAN 104, the service provider associated with the PWLAN 104 may utilize a separate MNFS 112 for delivery of message notifications. The domain name or IP address of the MNFS 112 may be transmitted along with the registration request. In some implementations, the domain name or IP address of the MNFS 112 may be added to the registration request by the AP 102. In other implementations, the mobile station 100 may include the domain name or IP address of the MNFS 112 in the registration request. The MNS 108 may use the address of either the AP 102 or the MNFS 112 as a delivery address for message notifications.

The AP 102 may forward the acknowledgement from the MNS 108 on to the mobile station 100 (process 212). To reduce its consumption of battery life, the mobile station 100 may enter a low power state, such as a sleep mode or a hibernation mode (process 214). In some implementations, the mobile station 100 may conserve power by reducing or minimizing the activity of its wireless card.

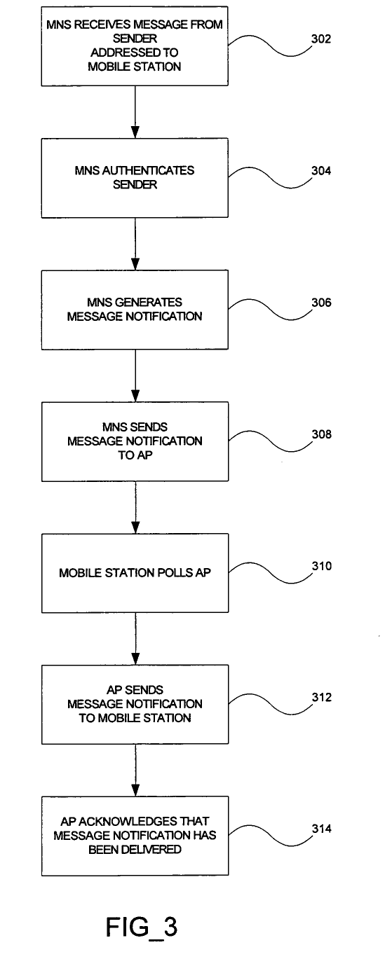

FIG. 3 describes a method, according to an implementation of the invention, for a message notification to be delivered to the mobile station 100. When a sender 110 wishes to communicate with the mobile station 100 (i.e., the sender 110 wishes to send a message to a user of the mobile station 100), the sender 110 may send a message to the MNS 108 (process 302 of FIG. 3). The message may be communicated to the MNS 108 over the network 106 such as the Internet.

The MNS 108 may authenticate the sender 110 (process 304). In an implementation, when a sender 110 attempts to send a message to the mobile station 100 through the MNS 108, the MNS 108 may verify that the public key or other identifier of the sender 110 is on the list of authorized senders. If there is a match, the sender 110 is authorized. If there is no match, the MNS 108 may deny or reject the request of the sender 110. The MNS 108 may also verify that the registration has not expired based on the expiration timestamp included in the registration request.

Once the sender 110 is authenticated and the registration is found to still be active, the MNS 108 may generate a message notification based on the message (process 306). In some implementations, the message notification may include a portion of the information contained in the message, including but not limited to an identity of the message sender, at least a portion of text from a subject line of the message, and at least a portion of text from a body of the message. In some implementations, the message notification may include other data associated with the message, including but not limited to the time and date the message was sent, the size of the message, and an importance level for the message (e.g., low, medium, or high importance).

The MNS 108 may send the message notification to the AP 102 (process 308). In accordance with the invention, the message notification may be addressed to the public key of the mobile station 100. If the message from the sender 110 was originally addressed to an identifier for the mobile station 100 that is not the public key (e.g., a user name), the MNS 108 may look up the public key associated with that identifier and then address the message notification to the public key. This protects the privacy of the mobile station 100 as well as the user of the mobile station 100. The MNS 108 is therefore able to support both name-based addressing and anonymous public key-based addressing. With name-based addressing, the privacy of the user is protected from the AP 102 since the translation from user name to public key is performed by the MNS 108.

The message notification may be communicated to the AP 102 over the network 106 such as the Internet. The message notification may be sent in lieu of the entire message to conserve bandwidth and possibly to provide the user of the mobile station 100 with an incentive to establish a full connection with the AP 102. In some implementations, the entire message from the sender 110 may be sent instead of a message notification. In implementations of the invention, the message notification may be encrypted and digitally signed prior to being sent to the AP 102. For example, the encryption may be carried out by encrypting a symmetric key using the public key, encrypting the message notification with the symmetric key, and delivering both to the AP 102 or the MNFS 112 for delivery.

In an implementation of the invention, the AP 102 may store the message notification received from the MNS 108 until it is polled by the mobile station 100 as the mobile station 100 may be in a low power state. The mobile station 100 may therefore periodically wake up and poll the AP 102 to determine whether any message notifications are pending (process 310). The poll message may also include a copy of the registration request in case the mobile station 100 has moved to a new location and has not registered its presence. If the AP 102 has already registered the mobile station 100, it may ignore the registration request.

When the AP 102 is polled, it may transmit the message notification to the mobile station 100 (process 312). The AP 102 may route the message notification to the mobile device 100 using its public key and device MAC address. The AP 102 may also contact the MNS 108 and acknowledge that the message notification was delivered to the mobile station 100 (process 314).

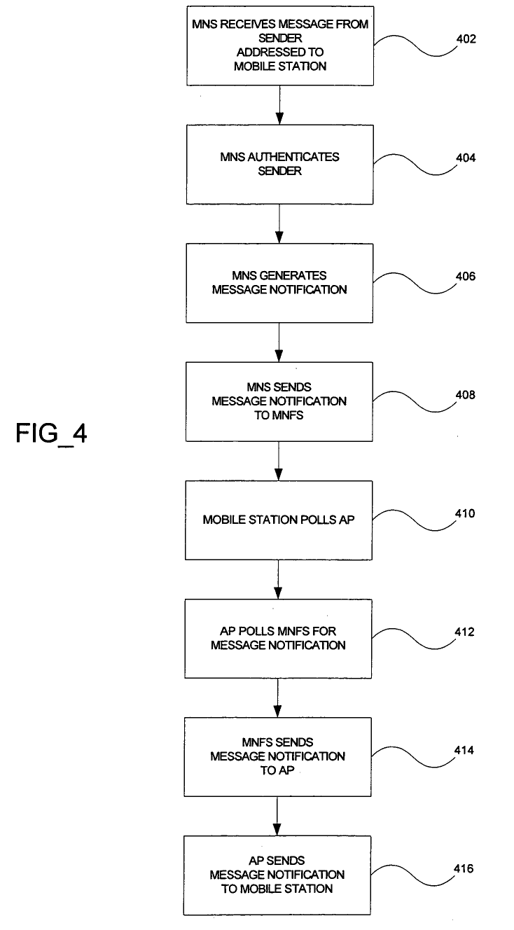

FIG. 4 describes a method, according to an implementation of the invention, for a message notification to be delivered to the mobile station 100 using the MNFS 112. The sender 110 begins by sending a message to the MNS 108 (process 402 of FIG. 4). Again, the message may be communicated to the MNS 108 over the network 106 such as the Internet and may be addressed to the public key or other identifier associated with the mobile station 100.

The MNS 108 may authenticate the sender 110 (process 404). The MNS 108 may also check that the registration has not expired based on the expiration timestamp included in the registration request. The MNS 108 may then generate a message notification (process 406) and send the message notification to the MNFS 112 (process 408). The message notification may be communicated to the MNFS 112 over the network 106 such as the Internet. In some implementations, the entire message may be sent instead of a message notification. The MNFS 112 may store the message notification received from the MNS 108 until the MNFS 112 is contacted by the AP 102.

The mobile station 100 may periodically wake up and poll the AP 102 to determine whether any message notifications are pending (process 410). When the AP 102 is polled, the AP 102 may in turn poll the MNFS 112 to determine whether any message notifications are pending (process 412). The MNFS 112 may then transmit the message notification to the AP 102 (process 414) and the AP 102 may forward the message notification to the mobile station 100 (process 416). In some implementations, the MNFS 112 may also contact the MNS 108 and acknowledge that the message notification was delivered to the mobile station 100.

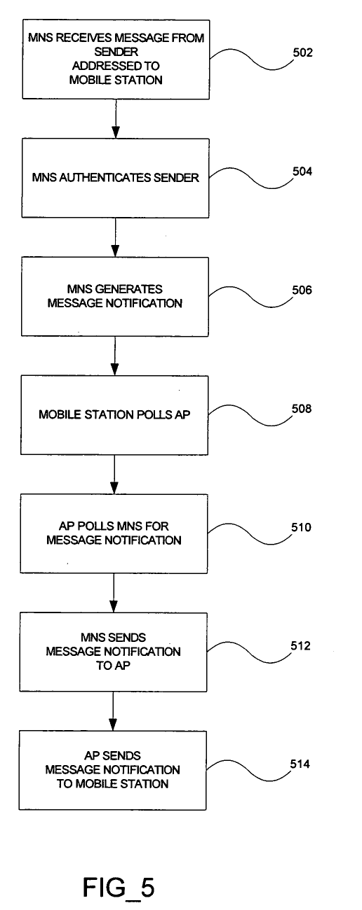

FIG. 5 describes a method, according to an implementation of the invention, for a message notification to be delivered to the mobile station 100 with the MNS 108 performing the functions of the MNFS 112 as well. The sender 110 begins by sending a message to the MNS 108 (process 502 of FIG. 5). Again, the message may be communicated to the MNS 108 over the network 106 such as the Internet and may be addressed to the public key or other identifier associated with the mobile station 100.

The MNS 108 may authenticate the sender 110 (process 504). The MNS 108 may also check that the registration has not expired based on the expiration timestamp included in the registration request. The MNS 108 may then generate a message notification based on the message (process 506) and store the message notification until the MNS 108 is contacted by the AP 102.

The mobile station 100 may periodically wake up and poll the AP 102 to determine whether any message notifications are pending (process 508). When the AP 102 is polled, the AP 102 may in turn poll the MNS 108 to determine whether any message notifications are pending (process 510). The MNS 108 may then transmit a message notification to the AP 102 (process 512) and the AP 102 may forward the message notification to the mobile station 100 (process 514).

Once the mobile station 100 receives the message notification, a user of the mobile station 100 may determine whether the pending message is important enough to establish a full connection to the AP 102 of the PWLAN 104. If so, the user may establish a full connection between the mobile station 100 and the AP 102, for instance by paying any required service fees, and download the message in its entirety. The message notification may include the identity of the sender 110 that sent the message to assist the user of the mobile station 100 in determining whether or not to establish a full connection. In implementations where the entire message is sent instead of a message notification, the user of the mobile station 100 may read the entire message without the need to establish a full connection to the AP 102.

In implementations of the invention, verification processes, such as verifying digital signatures, may be performed only when a message notification is to be delivered. This is the point at which a chargeable event would likely occur, and the verifications may help prevent spurious charges and undesired interruptions of the user. If the registration expires without any message notifications being sent to the mobile station 100, then no public key operations will be needed at all.

The MNS 108 may be used to verify messages sent by sender 110, the registration request, or both. If the registration request includes a digital signature, verifying the registration request may be deferred until a message has been received from a sender 110. The result of the verification may be cached so the verification need only be performed once per registration. If a second registration request is received from the mobile station 100 before a prior registration has expired, the MNS 108 may check the timestamps and update the registration information if the timestamp of the second request is later and the request is valid. The digital signature associated with the new registration request may be checked to ensure an unauthorized user may not overwrite a legitimate registration with a bogus registration. If the AP 102 and/or the MNFS 112 establish a secure channel with the MNS 108, for example using a Secure Sockets Layer or IPsec, there is a reduced need to perform public key operations during registration or message delivery.

This systems and methods of the invention described herein invention provide a novel registration and notification service that encourages more efficient use of network resources, preserves user privacy, and enables very low-power operation.

The invention may be implemented in one or a combination of hardware, firmware, and software. The invention may also be implemented as instructions stored on a machine-readable medium, which may be read and executed by a processing platform to perform the operations described herein. A machine-readable medium may include any mechanism for storing, transmitting, or receiving information in a form readable by a machine (e.g., a computer). For example, a machine-readable medium may include read only memory (ROM); random access memory (RAM), such as dynamic random access memory (DRAM); magnetic disk storage media; optical storage media; flash memory devices; electrical, optical, acoustical or other form of propagated signals (e.g., carrier waves, infrared signals, digital signals, the interfaces that transmit and/or receive those signals, etc.), and others.

The above description of illustrated implementations of the invention, including what is described in the Abstract, is not intended to be exhaustive or to limit the invention to the precise forms disclosed. While specific implementations of, and examples for, the invention are described herein for illustrative purposes, various equivalent modifications are possible within the scope of the invention, as those skilled in the relevant art will recognize.

These modifications may be made to the invention in light of the above detailed description. The terms used in the following claims should not be construed to limit the invention to the specific implementations disclosed in the specification and the claims. Rather, the scope of the invention is to be determined entirely by the following claims, which are to be construed in accordance with established doctrines of claim interpretation.

1. A method comprising:
registering a mobile station as ready to receive a message notification;
receiving a message addressed to the mobile station from a sender;
generating a message notification based on the message;
waiting for a poll message from an access point in communication with the mobile station; and
transmitting the message notification to the mobile station through the access point when the poll message is received.

2. The method of claim 1, wherein the registering of the mobile station comprises receiving a registration request from the mobile station, wherein the registration request includes a public key identifying the mobile station and an expiration timestamp.

3. The method of claim 2, wherein the registration request further includes a list of authorized senders.

4. The method of claim 3, further comprising:
authenticating the sender prior to generating the message notification; and
rejecting the message if the sender cannot be authenticated.

5. The method of claim 4, wherein the authenticating of the sender comprises looking for the identity of the sender on the list of authorized senders.

6. The method of claim 1, wherein the message notification comprises at least one data item copied out of the message from the sender.

7. The method of claim 6, wherein the at least one data item is a sender identity, a subject line of the message, a portion of text from a body of the message, a time and date the message was sent, a size of the message, or an importance level for the message.

8. The method of claim 1, wherein the waiting for the poll message from the access point comprises waiting for a poll message from the mobile station by way of the access point.

9. An article comprising a machine-readable medium that provides instructions, which when executed by a processing platform, cause the processing platform to perform operations comprising:
registering a mobile station as ready to receive a message notification;
receiving a message addressed to the mobile station from a sender;
generating a message notification based on the message;
waiting for a poll message from an access point in communication with the mobile station; and
transmitting the message notification to the mobile station through the access point when the poll message is received.

10. The article of claim 9, wherein the operation of registering the mobile station comprises an operation of receiving a registration request from the mobile station, wherein the registration request includes a public key identifying the mobile station and an expiration timestamp.

11. The article of claim 10, wherein the registration request further includes a list of authorized senders.

12. The article of claim 11, wherein the operations further comprise:
authenticating the sender prior to generating the message notification; and
rejecting the message if the sender cannot be authenticated.

13. The article of claim 12, wherein the operation of authenticating the sender comprises an operation of looking for the identity of the sender on the list of authorized senders.

14. The article of claim 9, wherein the operation of waiting for the poll message from the access point comprises an operation of waiting for a poll message from the mobile station by way of the access point.

15. A system comprising:
a memory;
a processor; and
a software application residing in the memory that provides instructions, which when executed by the processor, cause the processor to perform operations comprising:
registering a mobile station as ready to receive a message notification;
receiving a message addressed to the mobile station from a sender;
generating a message notification based on the message;
waiting for a poll message from an access point in communication with the mobile station; and
transmitting the message notification to the mobile station through the access point when the poll message is received.

16. The system of claim 15, wherein the operation of registering the mobile station comprises an operation of receiving a registration request from the mobile station, wherein the registration request includes a public key identifying the mobile station and an expiration timestamp.

17. The system of claim 15, wherein the operations further comprise:
authenticating the sender prior to generating the message notification; and
rejecting the message if the sender cannot be authenticated.

18. A method comprising:
registering a mobile station as ready to receive a message notification;
receiving a message addressed to the mobile station from a sender;
generating a message notification based on the message; and
transmitting the message notification to a message notification forwarding system.

19. The method of claim 18, wherein the message notification forwarding system is capable of:
receiving a message notification addressed to a mobile station;
waiting for a poll message from an access point in communication with the mobile station; and
transmitting the message notification to the mobile station by way of the access point when the poll message is received.

20. The method of claim 19, wherein the registering of the mobile station comprises receiving a registration request from the mobile station, wherein the registration request includes a public key identifying the mobile station, an expiration timestamp, and a list of authorized senders.

21. The method of claim 20, further comprising:
looking for the identity of the sender on the list of authorized senders; and
rejecting the message if the identity of the sender cannot be found.

22. The method of claim 19, wherein the message notification comprises at least one data item copied out of the message from the sender, and wherein the at least one data item is a sender identity, a subject line of the message, a portion of text from a body of the message, a time and date the message was sent, a size of the message, or an importance level for the message.

23. An article comprising a machine-readable medium that provides instructions, which when executed by a processing platform, cause the processing platform to perform operations comprising:
registering a mobile station as ready to receive a message notification;
receiving a message addressed to the mobile station from a sender;
generating a message notification based on the message; and
transmitting the message notification to a message notification forwarding system.

24. The article of claim 23, wherein the message notification forwarding system is capable of:
receiving a message notification addressed to a mobile station;
waiting for a poll message from an access point in communication with the mobile station; and
transmitting the message notification to the mobile station by way of the access point when the poll message is received.

25. A method comprising:
registering a mobile station as ready to receive a message notification;
receiving a message addressed to the mobile station from a sender;
authenticating the sender;
generating a message notification based on the message; and
transmitting the message notification to the mobile station by way of an access point in communication with the mobile station.

26. The method of claim 25, wherein the registering of the mobile station comprises receiving a registration request from the mobile station, wherein the registration request includes a public key identifying the mobile station, an expiration timestamp, and a list of authorized senders.

27. The method of claim 26, further comprising rejecting the message if the sender cannot be authenticated based on the list of authorized senders.

28. A fee-based access point configured to carry out a method comprising:
allowing a mobile station to establish a minimal connection with the access point without incurring a fee;
receiving a registration request from the mobile station;
forwarding the registration request to a message notification system;
receiving a message notification from the message notification system;
waiting for a poll message from the mobile station; and
forwarding the message notification to the mobile station when the poll message is received.

29. The fee-based access point of claim 28, wherein the method further comprises:
recording a public key for the mobile station from the registration request; and
recording a MAC address for the mobile station.

30. The fee-based access point of claim 28, wherein the message notification is forwarded to the mobile station using the public key and the MAC address.
